(19) United States
(12) Patent Application Publication
(10) Pub. No.: US 2006/0001868 A1
(43) Pub. Date: Jan. 5, 2006

(54) System and method for spectroscopy and imaging

(76) Inventors: Shona Stewart, Pittsburgh, PA (US); Matthew P. Nelson, Harrison City, PA (US); Joseph E. Demuth, Pittsburgh, PA (US); Patrick J. Treado, Pittsburgh, PA (US)

Correspondence Address: DUANE MORRIS LLP, Suite 700, 1667 K Street, N.W., Washington, DC, 20006, US

(21) Appl. No.: 10/879,633

(22) Filed: Jun. 30, 2004

(51) Int. Cl. G01J 3/44; G01N 21/65

(52) U.S. Cl. 356/301

(57) ABSTRACT

The disclosure relates to a substrate material for the improved detection, resolution and imaging of biological material for spectroscopic characterization by Raman of optical imaging spectroscopy. The substrate provides a uniform, optically flat, highly reflective surface which can be made hydrophobic to prevent spreading of the sample and facilitating its optical evaluation. Moreover, the substrate can be coated with a material that does not emit Raman scattered photons when exposed to said illuminating photons. The principles disclosed herein allow a low spectroscopic background particularly suitable for examining small samples or samples having low concentrations of the suspected component.

The instant specification relates to application Ser. Nos.______ and______ filed concurrently herewith and entitled, respectively, Method and Apparatus for Peak Compensation in an Optical Filter Method and Apparatus for Spectral Modulation Compensation. Each of said application is incorporated herein in its entirety for background information.

### BACKGROUND

Conventional spectroscopic imaging systems are generally based on the application of high resolution, low aberration lenses and systems that produce images suitable for visual resolution by a human eye. These imaging systems include both microscopic spectral imaging systems as well as macroscopic imaging systems and use complex multi-element lenses designed for visual microscopy with high resolution aberrations optimized for each desired magnification. Transmitting illumination through such complex lenses attenuates the incident beam and creates spurious scattered light.

The spectroscopic detection or imaging of biological samples or biological components are also complicated by the signal arising from either the substrate material or from the pre-absorbed material on the substrate. Such biological samples (or compounds from biological samples) typically have very weak optical emission or scattering signals and are often dominated by the signal from the underlying substrate. Substrates commonly used for the microscopic study and observation of biological material are selected for bright field optical imaging under a microscope. However, such substrates are not spectroscopically clean and produce spectroscopic background noise that interfere or block important spectral regions of the sample required for Raman and optical evaluations. Specialized samples are commercially available for Raman studies of biological samples but they are generally complicated and costly.

Biological samples have been conventionally placed on glass or quartz slides for microscopic or spectroscopic examination. As stated, such substrates produce additional spectroscopic features when used for other optical characterization such as Raman spectroscopy or imaging spectroscopy. Fused quartz substrates have been used for micro-Raman spectroscopy but the material produces spectral features at low Raman scattering. Other optically clear, pure crystalline material such as CaF or MgF can provide low background noise for Raman spectroscopy. However, such materials are even more costly. Finally, stainless detection slides have been considered for Raman spectroscopy. Stainless slides include a polished stainless steel substrate and a thin Teflon coating. The high manufacturing cost renders these products impractical.

Thus, there is a need for a low cost, highly efficient detection slide that overcomes these and other problems.

### SUMMARY OF THE DISCLOSURE

In one embodiment, the disclosure relates to a system for producing a spatially accurate wavelength-resolved image of a sample (e.g., a Raman image). The system includes a sample mounted on a substrate and a device for emitting photons to illuminate the sample and thereby produce sample-scattered photons. The photons scattered by the sample include Raman scattered photons from the sample. The system may include an optical device, a tunable filter and a charge-coupled device. The optical device receives the scattered photons and produces imaging photons. The tunable filter and the charge-coupled device receive the imaging photons and form the spatially accurate wavelength-resolved image of the sample. To address background noise from the substrate, the substrate can be coated with a material that when exposed to illuminating photons does not emit a substantial amount of Raman scattered photons in comparison with the amount of Raman scattered photons from the sample. The coating can include a metal, aluminum, gold or silver.

According to another embodiment, the disclosure relates to a system for producing a spatially accurate wavelength-resolved image of a sample. The system may include a sample placed on a substrate, a photon source for illuminating the sample with illuminating photons and an optical device for collecting photons scattered by the sample. The photons scattered by the sample include Raman scattered photons. The system may also include a tunable filter for receiving the collected photons and passing certain of the collected photons having a wavelength in a predetermined wavelength band to produce imaging photons. Alternatively, the tunable filter can be configured to receive the collected photons and block ones of the collected photons having a wavelength that is not within a predetermined wavelength band to thereby produce imaging photons having a wavelength that is within the predetermined wavelength band. A charge-coupled device can be included for receiving the imaging photons and producing the spatially accurate wavelength-resolved image. To enhance Raman resolution and to overcome background noise from the substrate, the substrate can be coated with one or more layers that when exposed to said illuminating photons do not emit a substantial amount of Raman scattered photons in comparison to the amount of Raman scattered photons from the sample.

According to another embodiment, the disclosure relates to a method for producing a spatially accurate wavelength-resolved image of a sample by placing the sample on a substrate, providing illuminating photons, receiving photons scattered by the sample and forming collected photons. The photons scattered by the sample include Raman scattered photos from the sample. Next, certain of the collected photons having a wavelength in a predetermined wavelength band can be processed to produce imaging photons. Alternatively, collected photons having a wavelength that is not in a predetermined wavelength band can be blocked to thereby produce imaging photons having wavelength that is in the predetermined wavelength band. The imaging photons can be further processed to form a spatially accurate wavelength-resolved image To enhance Raman resolution and overcome background noise from the substrate, the substrate can be coated with one or more layers that when exposed to said illuminating photons do not emit a substantial amount of Raman scattered photons in comparison to the amount of Raman scattered photons from the sample.

### BRIEF DESCRIPTION OF THE DRAWINGS

FIG. 1 is a schematic representation of a conventional Raman imaging system; and

FIG. 2 is a schematic representation of a Raman imaging system according to an embodiment of the disclosure.

### DETAILED DESCRIPTION OF THE DISCLOSURE

Application of Raman spectroscopy with certain biomedical samples including cells, tissues, bacteria, viruses and other biological entities can result in weak Raman scattering (i.e., wavelengths of less than 800 cm₋₁). The weak scattering can result in degraded detection of the sample under review. The Raman image may be adversely affected by optical properties of the detection slide which receives the sample. The embodiments disclosed herein enable better detection and clearer spectroscopic resolution of a sample than conventionally possible. The embodiments disclosed herein are particularly suitable for detecting samples at low concentration. It shall be understood that a “Raman image” also refers to a “Raman chemical image”.

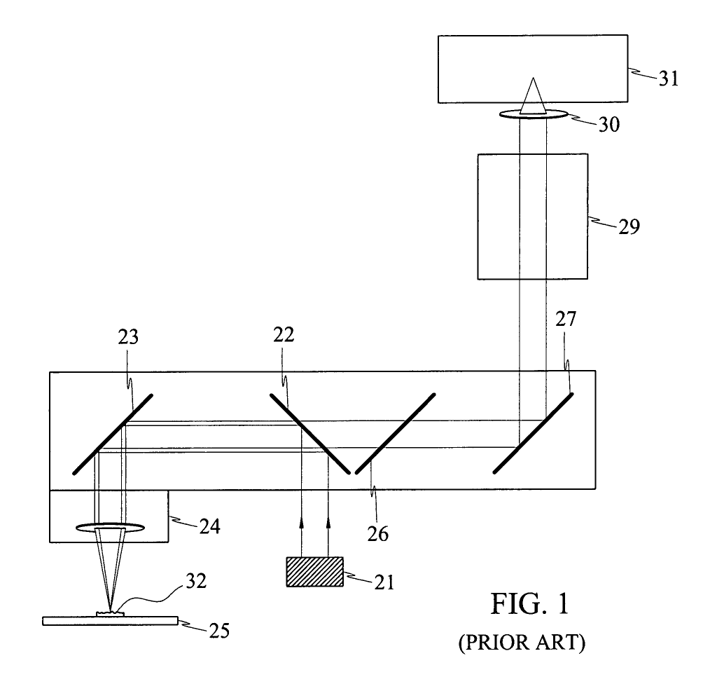

FIG. 1 is a schematic representation of a conventional Raman imaging system. Referring to FIG. 1, sample 32 is placed on a slide 25 within the purview of objective lens 24. As will be obvious to those of skill in the art, the slide 25 may be a substrate. Light source 21 (i.e., laser) provides illumination to sample 32 vis-à-vis beam-splitter 22 and mirror 23. Mirror 23 is also positioned to receive and redirect the sample's image in the form of scattered photons emanating from sample 32 to mirror 27. The photons scattered by the sample include Raman scattered photons from the sample.

Beam-splitter 22 may include a 50/50 beam-splitter, a dielectric interference, a dichroic beam-splitter or a holographic optical filter. Optionally laser rejection filter 26 may be placed between beam-splitter 22 and mirror 27 to remove the laser light while transmitting other wavelengths of the optical beam directed through beam-splitter device 22. Laser rejection filter 26 may include a dielectric interference filter, a holographic optical filter or a rugate optical filter. The scattered photons are then directed to tunable filter 28 and then to the focal plane array (FPA) device 31 through lens 30. The FPA may include silicon charge-coupled device (CCD) detector, charge-injection device (CID) detector or infrared FPA.

The light entering tunable filter 29 is not limited to the scattered photons from sample 32. Instead, the light entering filter 29 includes background photons which will affect the quality of the Raman image. Such background photons may include photons scattered by detection slide 25 as well as Raman scattered photons from the sample. Experiments with certain LCTF devices show that complicated interactions arising in the material and the imaging device can produce a spatial and spectral modulation of light going through the imaging device. The additional photons produce an apparent background signal that is not uniform and masks the real signal. Some of the background signal can be attributed to the optical nature of detection slide 25. Background signals cause interference which in turn result in a poor quality Raman image.

To address these problems, in one embodiment the disclosure relates to a detection slide having a uniform, optically flat and highly reflective surface. The detection slide includes a substrate coated with a material that when exposed to the illuminating photons it does not emit a substantial amount of Raman scattered photons in comparison to the amount of said Raman scattered photons from the sample. In addition, the substrate may be coated with one or more optional layers to obtain the desired physical, optical and chemical surface characteristics.

Any of the conventional slides used for optical microscopy examination can be used as a substrate. Conventional slides have glass or quartz substrate suitable for receiving chemical or biological samples. Most of the biological samples are stained to bring out various features of the sample. Consequently, the samples may be in the liquid form. To prevent movement of a liquid sample (i.e., spreading) it is desirable to provide a hydrophobic substrate. In one embodiment, the substrate is inherently hydrophobic so as to prevent spreading out of solvents carrying biological agents. If the substrate is not inherently hydrophobic, its surface(s) can be made hydrophobic by coating the substrate with one ore more layers of a hydrophobic material. Coating can also be used to obtain a desired pH value or to change the optical properties of the substrate (e.g., reflective index).

Coating the substrate can be done with any of a number of techniques. For example, the substrate can be coated by polishing a layer of the desired material thereon. Another effective technique is the evaporation of aluminum on the substrate's flat surface. It has been found that the latter provides a more uniform coating. Other deposition techniques include vacuum deposition, sputtering, chemical vapor deposition and dipping.

Referring again to FIG. 1, both sample 32 and detection slide 25 receive illuminating photons from light source 21. Conventional detection slide 25 emits Raman scattered photons which are received by filter 29 and FPA 31. According to an embodiment of the disclosure, detection slide 25 may be coated such that it does not emit Raman scattered photons when exposed to the illuminating photons. Alternatively, the substrate of detection slide 25 may be coated with one or more layer such that it does not emit Raman scattered photons when exposed to the illuminating photons. The substrate may have an optically smooth surface. In one embodiment, the substrate can be a microscope slide coated with a metallic or polymeric film which does not emit Raman scattered photons when exposed to said illuminating photons.

In one embodiment, a layer of an aluminum film is exposed to moist air and reacts to form an extremely uniform Al₂O₃ layer on the top surface of the deposited aluminum on the substrate or slide. Other compositions that can be used for coating the substrate include metals, gold or silver and metallic alloys containing aluminum, gold or silver. After deposition, the coated aluminum layer is exposed to or treated with reagents to form a surface layer having a defined pH value. This simple aluminum oxide layer is an ideal self passivating layer which is extremely uniform and is typically about 20 to 40 Å thick.

In one embodiment, the disclosure relates to a system for producing a spatially accurate wavelength-resolved image of a sample. The system may include a slide for receiving the sample, a photon source for illuminating the sample on the slide, an optical device for receiving photons scattered by the sample to thereby produce collected photons. The substrate can be coated with a material that does not emit Raman scattered photons when exposed to said illuminating photons. The system may also include a tunable filter for receiving the collected photons and passing certain collected photons having a wavelength in a predetermined wavelength band and producing imaging photons. Alternatively, the system may include a tunable filter for receiving the collected photons and blocking certain of the collected photons having a wavelength not within a predetermined wavelength band to thereby produce imaging photons having wavelength within the predetermined wavelength band. A charge-coupled device can be provided to receive the imaging photons from the tunable filter and produce a spatially accurate wavelength-resolved Raman image of the sample.

According to another embodiment, a method for producing a Raman image of a sample includes providing a sample mounted on a substrate, illuminating the sample with illuminating photons, receiving photons scattered by the sample when illuminated by the illuminating photons to thereby produce collected photons. Next, certain collected photons having a wavelength in a predetermined wavelength band can be passed through an optical device to produce imaging photons. Alternatively, the collected photons can be filtered so as to block certain of the collected photons having a wavelength outside of a predetermined wavelength band to produce imaging photons having a wavelength that is within the predetermined wavelength band. The imaging photons can be processed by an FPA to produce a Raman image of the sample. The substrate can be coated with a material that does not emit Raman scattered photons when exposed to said illuminating photons.

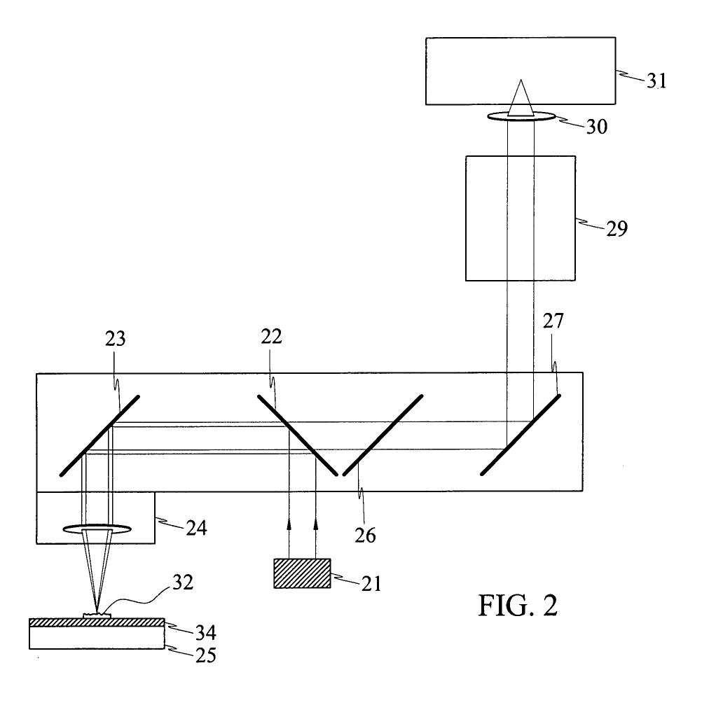

FIG. 2 is a schematic representation of a Raman imaging system according to an embodiment of the disclosure. In the exemplary embodiment of FIG. 2, detection slide 25 is shown to have a coating film 34 formed thereupon. Film 34 can comprise one or several layers of coating films. Each coating film can include a different composition specifically calculated to produce a desired chemical, mechanical or optical property. For example, film 34 can include one or more of a film containing metal, such as aluminum, silver or gold. In one embodiment, film 34 may be a layer of Al₂O₃.

Although the principles disclosed herein have been described in relation to the non-exclusive exemplary embodiments provided herein, it should be noted that the principles of the disclosure are not limited thereto and include permutations and modifications not specifically described.

What is claimed is:

1. In a system for producing a spatially accurate wavelength-resolved image of a sample mounted on a first substrate where the system includes:
a device for emitting photons to illuminate the sample to thereby produce photons scattered by the sample where the sample-scattered photons include Raman scattered photons from the sample;
an optical device for receiving the scattered photons to thereby produce imaging photons;
a tunable filter; and
a charge coupled device;
the improvement comprising mounting the sample on a second substrate that is coated with a material that when exposed to said illuminating photons does not emit a substantial amount of Raman scattered photons in comparison to the amount of said Raman scattered photons from the sample.

2. The system of claim 1 wherein the first substrate and the second substrate each have an optically smooth surface.

3. The system of claim 1 wherein the coating material is aluminum.

4. The system of claim 1 wherein the coating material is gold.

5. The system of claim 1 wherein the coating material is silver.

6. The system of claim 1 wherein the second substrate is a microscope slide.

7. A system for producing a spatially accurate wavelength-resolved image of a sample comprising:
said sample mounted on a substrate;
a photon source for providing illuminating photons;
an optical device for receiving photons scattered by said sample when illuminated by said illuminating photons to thereby produce collected photons where said photons scattered by said sample include Raman scattered photons from said sample;
a tunable filter for receiving said collected photons and passing ones of said collected photons having a wavelength in a predetermined wavelength band to thereby produce imaging photons;
a charge coupled device for receiving said imaging photons to thereby produce a spatially accurate wavelength-resolved image, wherein said substrate is coated with a material that when exposed to said illuminating photons does not emit a substantial amount of Raman scattered photons in comparison to the amount of Raman scattered photons from said sample.

8. The system of claim 7 wherein the substrate has an optically smooth surface.

9. The system of claim 7 wherein the substrate is a microscope slide.

10. The system of claim 7 wherein said coating is metal.

11. The system of claim 7 wherein said coating is aluminum.

12. The system of claim 7 wherein said coating is gold.

13. The system of claim 7 wherein said coating is silver.

14. A system for producing a spatially accurate wavelength-resolved image of a sample comprising:
said sample mounted on a substrate;
a photon source for providing illuminating photons;
an optical device for receiving photons scattered by said sample when illuminated by said illuminating photons to thereby produce collected photons where said photons scattered by said sample include Raman scattered photons from said sample;
a tunable filter for receiving said collected photons and blocking ones of said collected photons having a wavelength that is not in a predetermined wavelength band to thereby produce imaging photons having a wavelength that is in said predetermined wavelength band;
a charge coupled device for receiving said imaging photons to thereby produce a spatially accurate wavelength-resolved image,
wherein said substrate is coated with a material that when exposed to said illuminating photons does not emit a substantial amount of Raman scattered photons in comparison to the amount of Raman scattered photons from said sample.

15. The system of claim 14 wherein the substrate has an optically smooth surface.

16. The system of claim 14 wherein the substrate is a microscope slide.

17. The system of claim 14 wherein said coating is metal.

18. The system of claim 14 wherein said coating is aluminum.

19. The system of claim 14 wherein said coating is gold.

20. The system of claim 14 wherein said coating is silver.

21. A method for producing a spatially accurate wavelength-resolved image of a sample comprising:
providing the sample mounted on a substrate;
providing illuminating photons;
receiving photons scattered by said sample when illuminated by said illuminating photons to thereby produce collected photons where said photons scattered by said sample include Raman scattered photons from said sample;
receiving said collected photons and passing ones of said collected photons having a wavelength in a predetermined wavelength band to thereby produce imaging photons;
receiving said imaging photons to thereby produce a spatially accurate wavelength-resolved image,
wherein said substrate is coated with a material that when exposed to said illuminating photons does not emit a substantial amount of Raman scattered photons in comparison to the amount of Raman scattered photons from said sample.

22. The method of claim 21 wherein the step of providing the sample includes providing the sample on an optically smooth surface.

23. The method of claim 21 wherein the step of providing the sample includes providing the sample on a microscope slide.

24. The method of claim 21 wherein the step of providing the sample includes providing the sample on a metal coated substrate.

25. The method of claim 21 wherein the step of providing the sample includes providing the sample on an aluminum coated substrate.

26. The method of claim 21 wherein the step of providing the sample includes providing the sample on a gold coated substrate.

27. The method of claim 21 wherein the step of providing the sample includes providing the sample on a silver coated substrate.

28. A method for producing a spatially accurate wavelength-resolved image of a sample comprising:
providing the sample mounted on a substrate;
providing illuminating photons;
receiving photons scattered by said sample when illuminated by said illuminating photons to thereby produce collected photons where said photons scattered by said sample include Raman scattered photons from said sample;
receiving said collected photons and blocking ones of said collected photons having a wavelength that is not in a predetermined wavelength band to thereby produce imaging photons having a wavelength that is in said predetermined wavelength band;
receiving said imaging photons to thereby produce a spatially accurate wavelength-resolved image,
wherein said substrate is coated with a material that when exposed to said illuminating photons does not emit a substantial amount of Raman scattered photons in comparison to the amount of Raman scattered photons from said sample.

29. The method of claim 28 wherein the step of providing the sample includes providing the sample on an optically smooth surface.

30. The method of claim 28 wherein the step of providing the sample includes providing the sample on a microscope slide.

31. The method of claim 28 wherein the step of providing the sample includes providing the sample on a metal coated substrate.

32. The method of claim 28 wherein the step of providing the sample includes providing the sample on an aluminum coated substrate.

33. The method of claim 28 wherein the step of providing the sample includes providing the sample on a gold coated substrate.

34. The method of claim 28 wherein the step of providing the sample includes providing the sample on a silver coated substrate.
